(19) United States
(12) Patent Application Publication
(10) Pub. No.: US 2014/0258942 A1
(43) Pub. Date: Sep. 11, 2014

(54) INTERACTION OF MULTIPLE PERCEPTUAL SENSING INPUTS

(71) Applicants: Intel Corporation, Santa Clara, CA (US); OMEK INTERACTIVE, LTD., Bet Shemesh, IL (US)

(72) Inventors: Gershom Kutliroff, Alon Shvut, IL (US); Yaron Yanai, Modiin, IL (US)

(73) Assignees: Intel Corporation, Santa Clara, CA (US); Omek Interactive, Ltd., Bet Shemesh, IL (US)

(21) Appl. No.: 13/785,669

(22) Filed: Mar. 5, 2013

(51) Int. Cl. G06F 3/0488

(52) U.S. Cl. CPC G06F 3/0488
USPC 715/863

(57) ABSTRACT

A system and method for using multiple perceptual sensing technologies to capture information about a user's actions and for synergistically processing the information is described. Non-limiting examples of perceptual sensing technologies include gesture recognition using depth sensors, two-dimensional cameras, gaze detection, and/or speech recognition. The information captured about a user's gestures using one type of sensing technology is often not able to be captured with another type of technology. Thus, using multiple perceptual sensing technologies allows more information to be captured about the user's gestures. Further, by synergistically leveraging the information acquired using multiple perceptual sensing technologies, a more natural user interface can be created for a user to interact with an electronic device.

### BACKGROUND

Recently, the consumer electronics industry has witnessed a renewed emphasis on innovation in the area of user interface technologies. As the progress of technology has enabled smaller form factors, and increased mobility, while concurrently increasing the available computing power, companies have focused on empowering users to more effectively interact with their devices. The touch screen is a notable example of a relatively new and widely adopted innovation in user experience. However, touch screen technology is only one of several user interaction technologies that are being integrated into consumer electronic devices. Additional technologies such as gesture control, gaze detection, and speech recognition, to name a few, are also becoming increasingly common. As a whole, these different solutions are referred to as perceptual sensing technologies.

### BRIEF DESCRIPTION OF THE DRAWINGS

FIG. 1 is a diagram illustrating an example environment in which a user interacts with one or more depth cameras and other perceptual sensing technologies.

FIG. 2 is a diagram illustrating an example environment in which a standalone device using multiple perceptual sensing technologies is used to capture user interactions.

FIG. 3 is a diagram illustrating an example environment in which multiple users interact simultaneously with an application designed to be part of an installation.

FIG. 4 is a diagram illustrating control of a remote device through tracking of a user's hands and/or fingers using multiple perceptual sensing technologies.

FIG. 5 is a diagram illustrating an example automotive environment in which perceptual sensing technologies are integrated.

FIGS. 6A-6F show graphic illustrations of examples of hand gestures that may be tracked. FIG. 6A shows an upturned open hand with the fingers spread apart; FIG. 6B shows a hand with the index finger pointing outwards parallel to the thumb and the other fingers pulled toward the palm; FIG. 6C shows a hand with the thumb and middle finger forming a circle with the other fingers outstretched; FIG. 6D shows a hand with the thumb and index finger forming a circle and the other fingers outstretched; FIG. 6E shows an open hand with the fingers touching and pointing upward; and FIG. 6F shows the index finger and middle finger spread apart and pointing upwards with the ring finger and pinky finger curled toward the palm and the thumb touching the ring finger.

FIGS. 7A-7D show additional graphic illustrations of examples of hand gestures that may be tracked. FIG. 7A shows a dynamic wave-like gesture; FIG. 7B shows a loosely-closed hand gesture; FIG. 7C shows a hand gesture with the thumb and forefinger touching; and FIG. 7D shows a dynamic swiping gesture.

FIG. 8 is a workflow diagram, describing an example process of tracking a user's hand(s) and finger(s) over a series of frames of captured images.

FIG. 9 illustrates an example of a user interface (UI) framework based on input from multiple perceptual sensing technologies.

FIG. 10 is a workflow diagram describing a user interaction based on multiple perceptual sensing technologies.

FIG. 11 is a workflow diagram describing another user interaction based on multiple perceptual sensing technologies

FIG. 12 is a block diagram of a system used to acquire data about user actions using multiple perceptual sensing technologies and to interpret the data.

### DETAILED DESCRIPTION

A system and method for using multiple perceptual sensing technologies to capture information about a user's actions and for synergistically processing the information is described. Non-limiting examples of perceptual sensing technologies include gesture recognition using depth sensors and/or two-dimensional cameras, gaze detection, and speech or sound recognition. The information captured using one type of sensing technology is often not able to be captured with another type of technology. Thus, using multiple perceptual sensing technologies allows more information to be captured about a user's actions. Further, by synergistically leveraging the information acquired using multiple perceptual sensing technologies, a more natural user interface can be created for a user to interact with an electronic device.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

Perceptual sensing technologies capture information about a user's behavior and actions. Generally, these technologies include a hardware component—typically some type of sensing device—and also an associated processing module for running algorithms to interpret the data received from the sensing device. These algorithms may be implemented in software or in hardware.

The sensing device may be a simple RGB (red, green blue) camera, and the algorithms may perform image processing on the images obtained from the RGB camera to obtain information about the user's actions. Similarly, the sensing device may be a depth (or “3D”) camera. In both of these cases, the algorithm processing module processes the videostream obtained from the camera (either RGB or depth video, or both), to interpret the movements of the user's hands and fingers, or his head movements or facial expressions, or any other information that can be extracted from a user's physical movements or posture.

Furthermore, the sensing device may be a microphone, or a microphone array for converting sounds, such as spoken words or other types of audible communication, into an electrical signal. The associated algorithm processing module may process the captured acoustic signal and translate it into spoken words or other communications.

An additional common perceptual sensing technology is a touch screen, in which case the algorithm processing module processes the data captured by the touch screen to understand the positions and movements of the user's fingers touching the screen.

A further example is gaze detection, in which a hardware device is used to capture information about where the user is looking, and the algorithm processing module may interpret this data to determine the direction of the user's gaze on a monitor or virtual scene.

These perceptual sensing technologies have broad applications, for example, speech recognition may be used to answer telephone-based queries, and gaze detection may be used to detect driver awareness. However, in the present disclosure, these perceptual sensing technologies will be considered in the context of enabling user interaction with an electronic device.

Gaze detection solutions determine the direction and orientation of a user's gaze. With a gaze detection solution, cameras may be used to capture images of the user's face, and then the locations of the user's eyes may be computed from the camera images, based on image processing techniques. Subsequently, the images may be analyzed to compute the direction and orientation of the subject's gaze. Gaze detection solutions may rely on active sensor systems, which contain an active illumination source, in addition to the camera. For example, the active illumination may project patterns onto the scene that are reflected from the cornea of the eyes, and these reflected patterns may be captured by the camera. Reliance on such an active illumination source may significantly improve the robustness and general performance of the technology.

Gaze detection can be used as an independent perceptual sensing technology, and can enable certain types of user interactions. For example, a user may rely on gaze detection to select virtual icons on his computer desktop, simply by looking at the icons for a predetermined amount of time. Alternatively, an electronic device, such as a computer, may detect when a user has read all of the available text in a window, and automatically scroll the text so the user can continue reading. However, because gaze detection is limited to tracking the direction of the user's gaze, such systems are unable to determine the goal of more complex user interactions, such as gestures and non-trivial manipulations of a virtual object.

Touch screens are a perceptual sensing technology that has become quite common in electronic devices. When a user touches a touch screen directly, the touch screen can sense the location on the screen where the user touched it. Several different touch screen technologies are available. For example, with a resistive touch screen, the user depresses a top screen so it comes into contact with a second screen beneath the top screen, and the position of the user's finger can then be detected where the two screens touch. Capacitive touch screens measure the change in capacitance caused by the touch of a user's finger. A surface acoustic wave system is an additional technology used to enable touch screens. Ultrasound-based solutions may also be used to enable a touch screen-like experience, and ultrasound may even detect touch screen-like user movements at a distance from the screen. Variations of these technologies, as well as other solutions, may also be used to enable a touch screen experience, and the choice of technology that is implemented may depend on factors such as cost, reliability, or features such as multi-touch, among other considerations.

Touch screens enable the user to directly touch and effect graphical icons displayed on a screen. The position of the user's touch is computed by particular algorithms and used as input to an application, such as a user interface. Moreover, touch screens can also enable a user to interact with the application using gestures, or discrete actions where the user's movements are tracked over several successive frames taken over a period of time. For example, a finger swipe is a gesture, as is a pinch of two fingers touching the screen. Touch screens are intuitive interfaces, insofar as they support natural human behavior for reaching out and touching items.

However, the extent to which touch screens understand the actions and intentions of users is limited. In particular, touch screens are generally unable to differentiate between the user's different fingers, or even between a user's two hands. Moreover, touch screens only detect the locations of the tips of the fingers, and therefore, are unable to detect the angle of the user's finger while he is touching the screen. Furthermore, if the user is not in very close proximity to the screen, or if the screen is particularly large, it can be uncomfortable for the user to reach out and touch the screen.

Speech recognition is yet another perceptive sensing technology for sensing an audible gesture. Speech recognition relies on a transducer or sensor that converts a sound to an electrical signal, such as a microphones or microphone array. The transducer can capture an acoustic signal, such as a user's voice, and utilize speech recognition algorithms (either in software or in hardware) to process the signal and translate it into discrete words and/or sentences.

Speech recognition is an intuitive and effective way in which to interact with an electronic device. Through speech, users can easily communicate complicated instructions to an electronic device, and also respond quickly to queries from the system. However, even state-of-the-art algorithms may fail to recognize the user's speech, for example, in noisy environments. In addition, the relevance of just speech for graphical user interaction is evidently limited, especially when considering functions such as moving a cursor over a screen and replacing functions that have a strong visual component, such as resizing a window.

An additional effective perceptual sensing technology is based on input captured from cameras, and interpreting this data to understand the movements of the user, and, in particular, the movements of the user's hands and fingers. The data representing the user's actions is captured by a camera, either a conventional RGB camera, or a depth camera.

RGB (“red-green-blue”) cameras, also known as “2D” cameras, capture the light from regions of a scene and project it onto a 2D pixel array, where each pixel value is represented by three numbers, corresponding to the amount of red, green and blue colored light at the associated region of the scene. Image processing algorithms may be applied to the RGB videostream to detect and track objects in the video. In particular, it may be possible to track the user's hands and face from the RGB videostream. However, the data generated by RGB cameras may be difficult to interpret accurately and robustly. In particular, it can be difficult to distinguish the objects in an image from the background of the image, especially when such objects occlude one another. Additionally, the sensitivity of the data to lighting conditions means that changes in the values of the data may be due to lighting effects, rather than changes in the object's position or orientation. The cumulative effect of these multiple problems is that it is generally not possible to track complex hand configurations in a robust, reliable manner. In contrast, depth cameras generate data that can support highly accurate, robust tracking of objects. In particular, the data from depth cameras may be used to track a user's hands and fingers, even in cases of complex hand articulations.

A depth camera captures depth images, generally a sequence of successive depth images, at multiple frames per second. Each depth image contains per-pixel depth data, that is, each pixel in the image has a value that represents the distance between a corresponding object in an imaged scene and the camera. Depth cameras are sometimes referred to as three-dimensional (3D) cameras. A depth camera may contain a depth image sensor, an optical lens, and an illumination source, among other components. The depth image sensor may rely on one of several different sensor technologies. Among these sensor technologies are time-of-flight, known as “TOF”, (including scanning TOF or array TOF), structured light, laser speckle pattern technology, stereoscopic cameras, active stereoscopic sensors, and shape-from-shading technology. Most of these techniques rely on active sensors that supply their own illumination source. In contrast, passive sensor techniques, such as stereoscopic cameras, do not supply their own illumination source, but depend instead on ambient environmental lighting. In addition to depth data, the cameras may also generate color (“RGB”) data, in the same way that conventional color cameras do, and the color data can be combined with the depth data for processing.

The data generated by depth cameras has several advantages over that generated by RGB cameras. In particular, the depth data greatly simplifies the problem of segmenting the background of a scene from objects in the foreground, is generally robust to changes in lighting conditions, and can be used effectively to interpret occlusions. Using depth cameras, it is possible to identify and track both the user's hands and fingers in real-time, even complex hand configurations.

U.S. patent application Ser. No. 13/532,609, entitled “System and Method for Close-Range Movement Tracking” describes a method for tracking a user's hands and fingers based on depth images captured from a depth camera, and using the tracked data to control a user's interaction with devices, and is hereby incorporated in its entirety. U.S. patent application Ser. No. 13/441,271, entitled “System and Method for Enhanced Object Tracking”, filed Apr. 6, 2012, describes a method of identifying and tracking a user's body part or parts using a combination of depth data and amplitude data from a time-of-flight (TOF) camera, and is hereby incorporated in its entirety in the present disclosure. U.S. patent application Ser. No. 13/676,017, entitled “System and Method for User Interaction and Control of Electronic Devices”, describes a method of user interaction based on depth cameras, and is hereby incorporated in its entirety.

The position of the camera is an important factor when using a camera to track a user's movements. Some of the embodiments described in the present disclosure assume a particular position of the camera and the camera's view from that position. For example, in a laptop, it may be desirable to place the camera at the bottom or top of the display screen. By contrast, in an automotive application, it may be desirable to place the camera on the ceiling of the automobile, looking down at the driver's hands.

For the purposes of this disclosure, the term “gesture recognition” refers to a method for identifying an action or set of actions performed by a user including, but not limited to, specific movements, pose configurations, gazes, spoken words, and generation of sounds. For example, gesture recognition may refer to identifying a swipe of a hand in a particular direction having a particular speed, a finger tracing a specific shape on a touch screen, a wave of a hand, a spoken command, and a gaze in a certain direction. Gesture recognition is accomplished by first capturing the input data, possibly based on any of the above perceptual sensing technologies, analyzing the captured data to identify features of interest, such as the joints of the user's hands and fingers, the direction of the user's gaze, and/or the user's spoken words; and then, subsequently, analyzing the captured data to identify actions performed by the user.

We have presented above a number of perceptual sensing technologies that may be used to extract information about the user's actions and intentions. These perceptual sensing technologies share a common goal which is to provide users with an interaction paradigm that more closely resembles the way users naturally interact with other people. Indeed, people communicate through several methods at the same time, using visual cues like gestures, by speaking, by touching objects, etc. Consequently, synergistically combining multiple perceptual sensing technologies and building a user interaction experience that leverages many of them simultaneously, or even all of them, may deliver a superior user interface (UI) experience. While there has been much effort invested in creating compelling user experiences for individual perceptual sensing technologies, there has been relatively little work to date in building engaging user experiences based on multiple perceptual sensing technologies.

Notably, the information captured by the different perceptual sensing technologies is, to a large extent, mutually exclusive. That is, the type of information captured by a particular technology is often not able to be captured by other technologies. For example, touch screen technology can accurately determine when a finger is touching the screen, but not which finger it is, or the configuration of the hand during contact with the touch screen. Further, the depth camera used for 3D camera-based tracking may be placed at the bottom of the screen, facing the user. In this scenario, the camera's field-of-view may not include the screen itself, and so the tracking algorithms used on the videostream data are unable to compute when the finger touches the screen. Clearly, neither touch screen nor camera-based hand tracking technologies can detect the direction of the user's gaze.

Furthermore, a general concern in designing user experiences is to divine the intention of the user, which may be unclear at times. This is particularly true when relying on perceptual sensing technologies for input of the user's actions, as such input devices may be the cause of false positives. In this case, other perceptual sensing technologies may be used to confirm a user's actions and thus limit the occurrences of false positives.

The present disclosure describes several techniques for combining the information obtained by multiple modalities to create a natural user experience incorporating these different inputs.

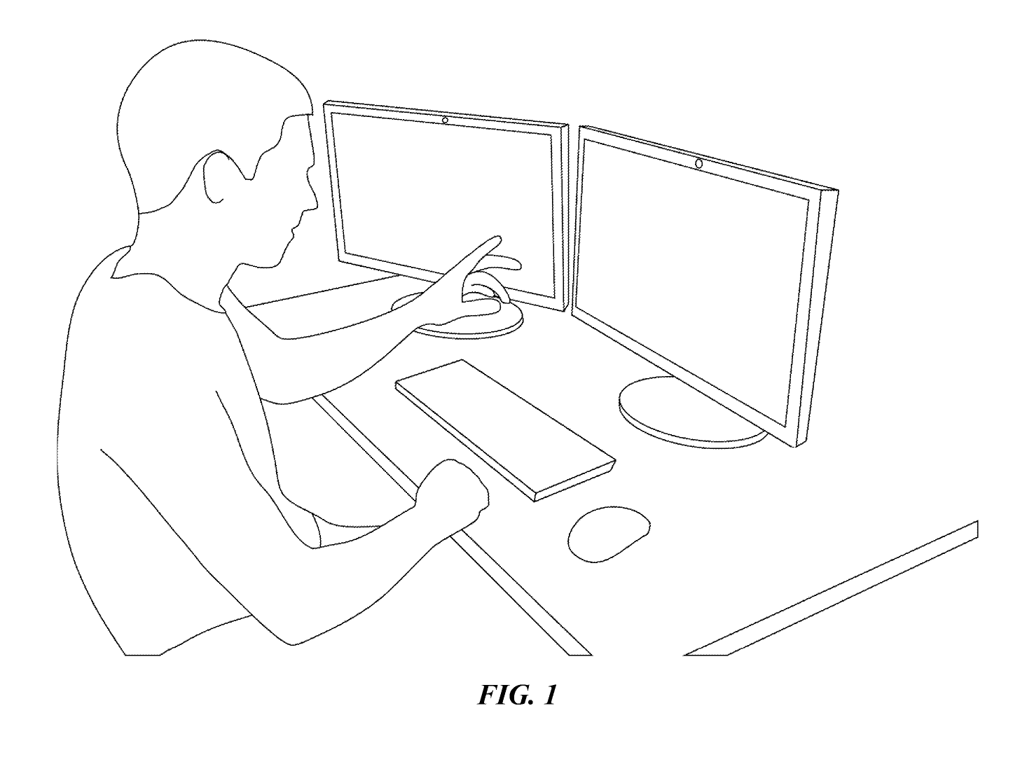

FIG. 1 is a diagram of a user interacting with two monitors at close-range. There may be a depth camera on each of the two monitors, or only one of the monitors may have a depth camera. In either case, one or more additional perceptual sensing technologies may be used along with the depth cameras. For example, there may be one or more microphones embedded in one or both of the monitors to capture the user's speech, the monitor screens may be touch screens, and there may also be gaze detection technology embedded into the monitors. The user is able to interact with the screens by moving his hands and fingers, by speaking, by touching the monitors, and by looking at different regions of the monitors. In all of these cases, different hardware components are used to capture the user's actions and deduce the user's intentions from his actions. Some form of feedback to the user is then displayed on the screens.

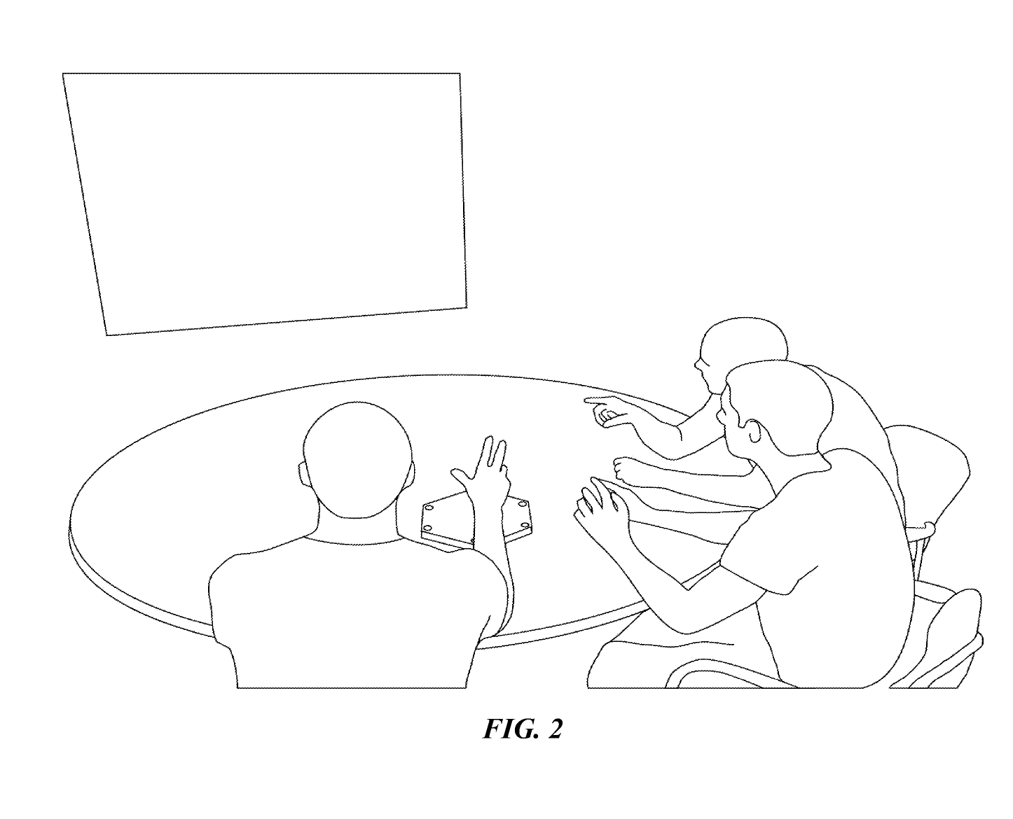

FIG. 2 is a diagram illustrating an example environment in which a standalone device using multiple perceptual sensing technologies is used to capture user interactions. The standalone device can contain a single depth camera, or multiple depth cameras, positioned around the periphery. Furthermore, microphones can be embedded in the device to capture the user's speech, and/or gaze detection technology may also be embedded into the device, to capture the direction of the user's gaze. Individuals can interact with their environment via the movements of their hands and fingers, with their speech, or by looking at particular regions of the screen. The different hardware components are used to capture the user's movements and deduce the user's intentions.

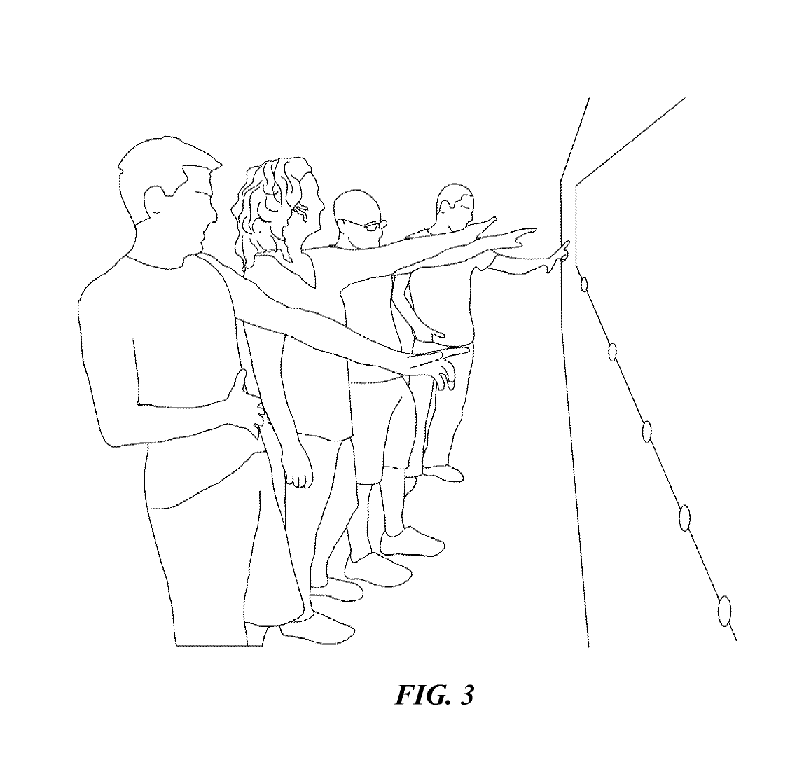

FIG. 3 is a diagram illustrating an example environment in which multiple users interact simultaneously with an application designed to be part of an installation. Multiple perceptual sensing technologies may be used to capture the user's interactions. In particular, there may be microphones embedded in the display to detect the user's speech, the display screens may be touch screens, and/or there may be gaze detection technology embedded into the displays. Each user may interact with the display by moving his hands and fingers, by speaking, by touching the touch screen display, and by looking at different regions of the display. The different hardware components are used to capture the user's movements and speech and deduce the user's intentions. Some form of feedback to the user is then displayed on the display screens.

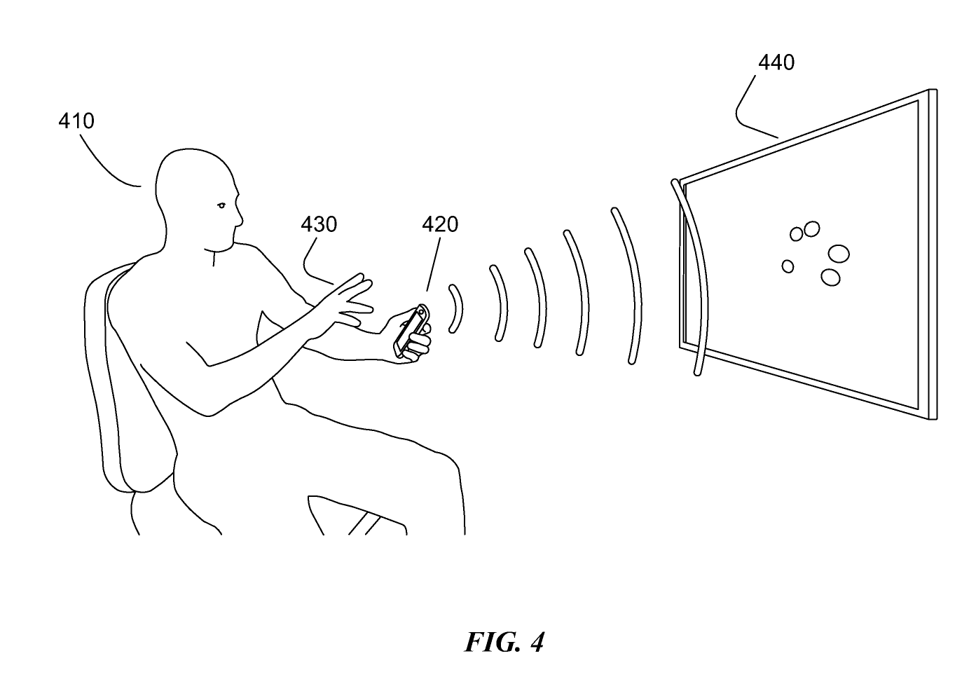

FIG. 4 is a diagram illustrating control of a remote device in which a user 410 moves his hands and fingers 430 while holding a handheld device 420 containing a depth camera. The depth camera captures data of the user's movements, and tracking algorithms are run on the captured videostream to interpret the user's movements. Multiple perceptual sensing technologies may be incorporated into the handheld device 420 and/or the screen 440, such as microphones, a touch screen, and gaze detection technology. The different hardware components are used to capture the user's movements and speech and deduce the user's intentions. Some form of feedback to the user is then displayed on the screen 440 in front of the user.

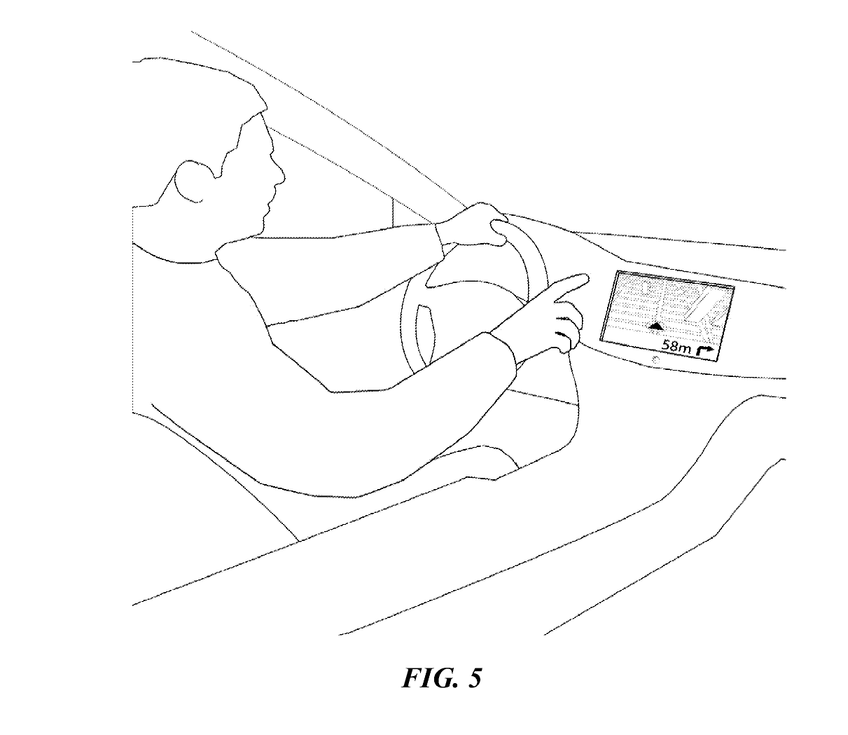

FIG. 5 is a diagram illustrating an example automotive environment in which perceptual sensing technologies are integrated. There may be a camera integrated into the automobile, either adjacent to the display screen, or on the ceiling of the automobile, so the driver's movements can be clearly captured. In addition, the display screen may be a touch screen, and there may be gaze detection technology integrated into the console of the automobile so the direction of the user's gaze may be determined. Moreover, speech recognition technology may also be integrated within this environment.

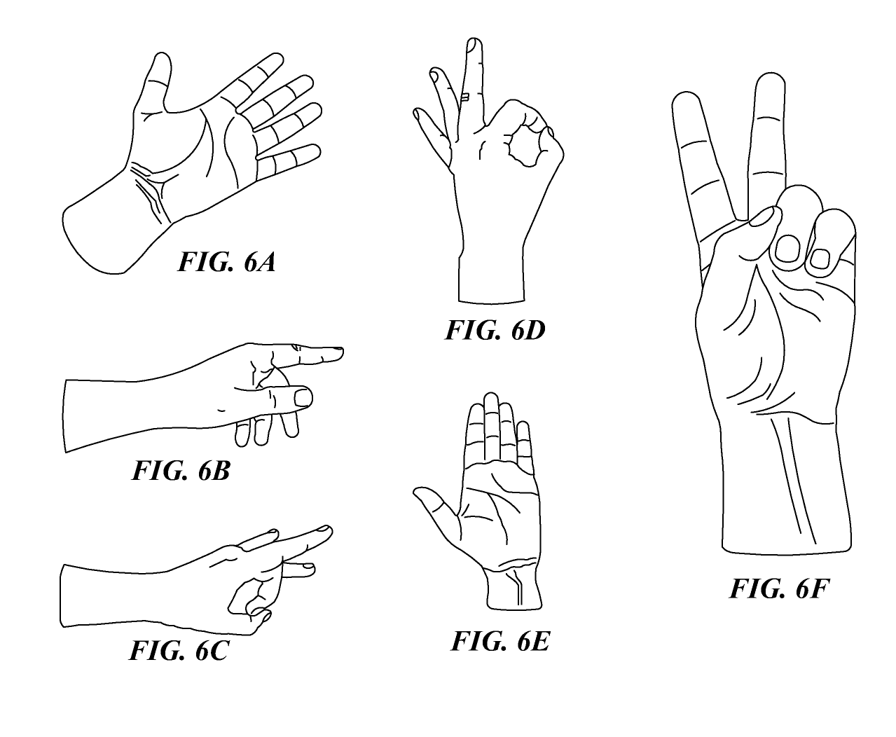

FIGS. 6A-6D are diagrams of several example gestures that can be detected by the camera tracking algorithms. FIG. 6A shows an upturned open hand with the fingers spread apart; FIG. 6B shows a hand with the index finger pointing outwards parallel to the thumb and the other fingers pulled toward the palm; FIG. 6C shows a hand with the thumb and middle finger forming a circle with the other fingers outstretched; FIG. 6D shows a hand with the thumb and index finger forming a circle and the other fingers outstretched; FIG. 6E shows an open hand with the fingers touching and pointing upward; and FIG. 6F shows the index finger and middle finger spread apart and pointing upwards with the ring finger and pinky finger curled toward the palm and the thumb touching the ring finger.

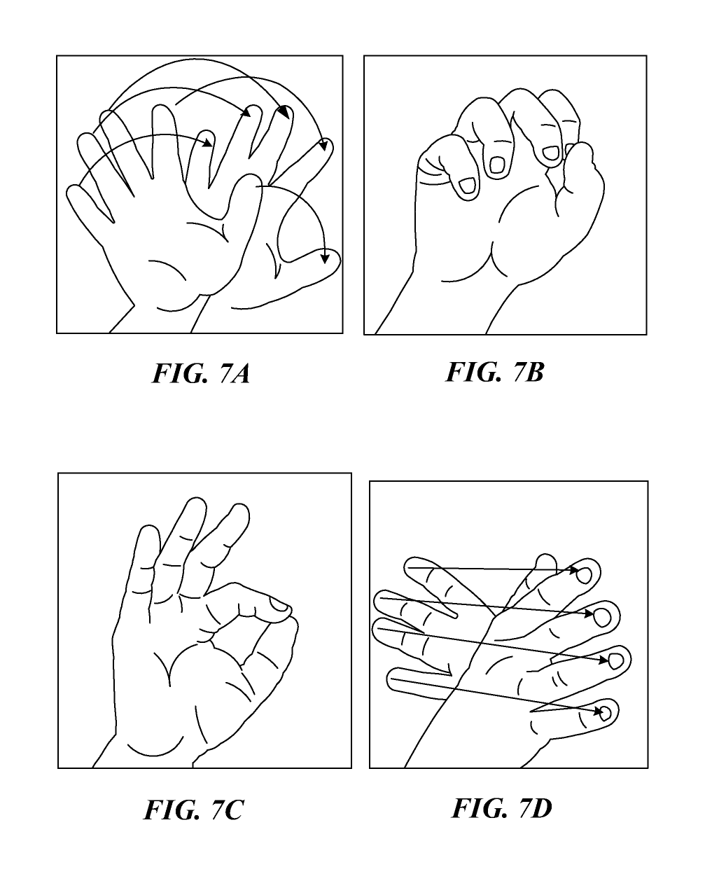

FIGS. 7A-7D are diagrams of an additional four example gestures that can be detected by the camera tracking algorithms. FIG. 7A shows a dynamic wave-like gesture; FIG. 7B shows a loosely-closed hand gesture; FIG. 7C shows a hand gesture with the thumb and forefinger touching; and FIG. 7D shows a dynamic swiping gesture. The arrows in the diagrams refer to movements of the fingers and hands, where the movements define the particular gesture. These examples of gestures are not intended to be restrictive. Many other types of movements and gestures can also be detected by the camera tracking algorithms.

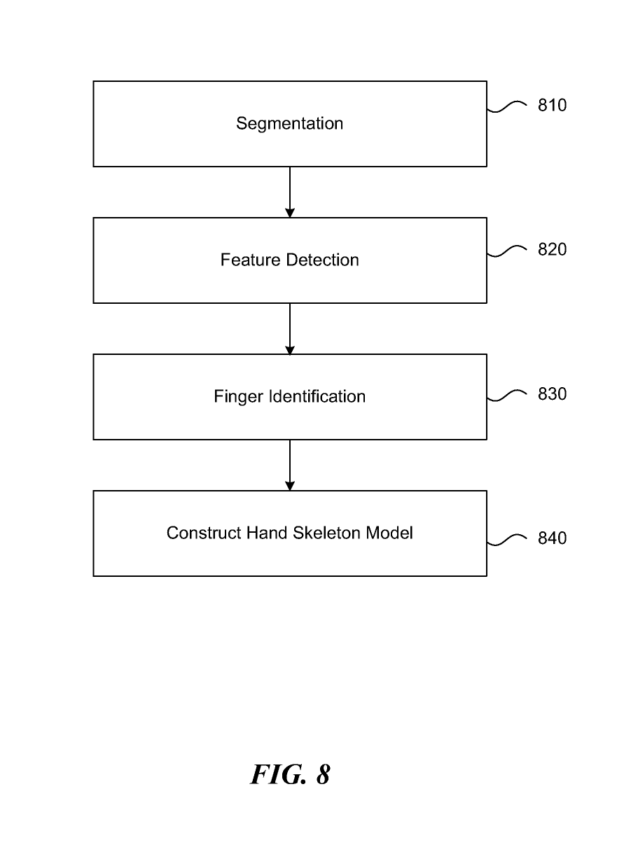

FIG. 8 is a workflow diagram, describing an example process of tracking a user's hand(s) and finger(s) over a series of frames of captured depth images. At stage 810, an object is segmented and separated from the background. This can be done, for example, by thresholding the depth values, or by tracking the object's contour from previous frames and matching it to the contour from the current frame. In some embodiments, the user's hand is identified from the depth image data obtained from the depth camera, and the hand is segmented from the background. Unwanted noise and background data is removed from the depth image at this stage.

Subsequently, at stage 820, features are detected in the depth image data and associated amplitude data and/or associated RGB images. These features may be, in some embodiments, the tips of the fingers, the points where the bases of the fingers meet the palm, and any other image data that is detectable. The features detected at 820 are then used to identify the individual fingers in the image data at stage 830.

At stage 840, the 3D points of the fingertips and some of the joints of the fingers may be used to construct a hand skeleton model. The skeleton model may be used to further improve the quality of the tracking and assign positions to joints which were not detected in the earlier steps, either because of occlusions, or missed features, or from parts of the hand being out of the camera's field-of-view. Moreover, a kinematic model may be applied as part of the skeleton, to add further information that improves the tracking results. U.S. application Ser. No. 13/768,835, entitled “Model-Based Multi-Hypothesis Object Tracker,” describes a system for tracking hand and finger configurations based on data captured by a depth camera, and is hereby incorporated in its entirety.

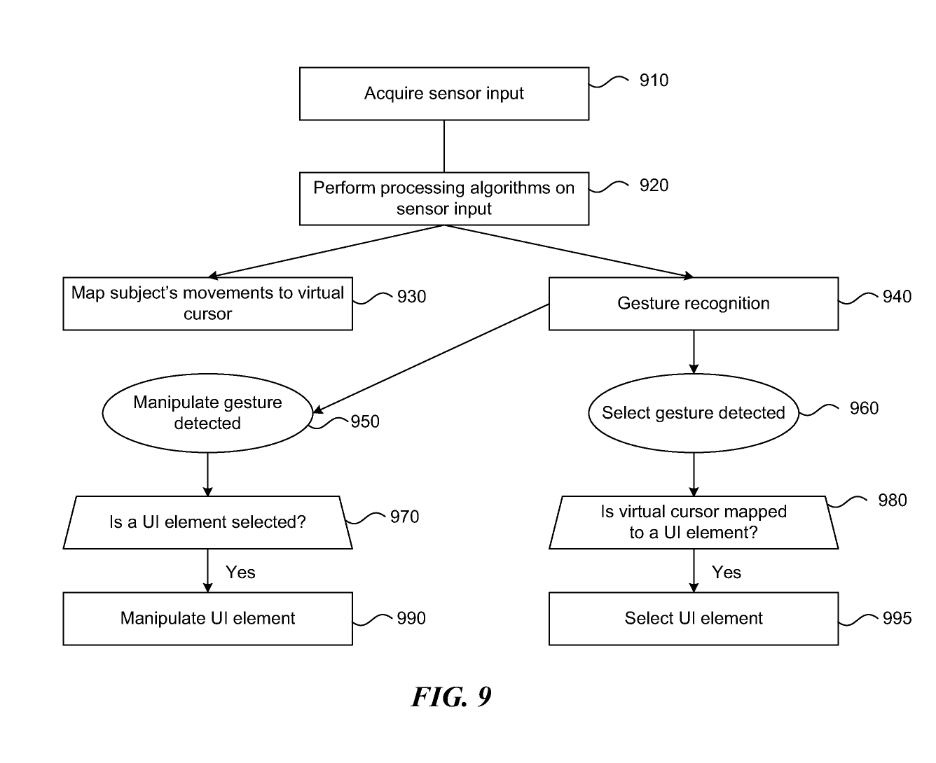

Reference is now made to FIG. 9, which illustrates an example of a user interface (UI) framework based on input from multiple perceptual sensing technologies.

At stage 910, input is obtained from various perceptual sensing technologies. For example, depth images may be acquired from a depth camera, raw images may be acquired from a gaze detection system, raw data may be acquired from touch screen technology, and an acoustic signal may be acquired from microphones. At stage 920, these inputs are processed, in parallel, by the respective algorithms.

The sensed data, which may represent the user's movements (touch, hand/finger movements, and eye gaze movements), and may, in addition, represent his speech, is then processed in two parallel paths, as described below. At stage 930, the data representing the user's movements may be used to map or project the subject's hand, finger, and/or eye movements to a virtual cursor. Information may be provided on a display screen to provide feedback to the subject. The virtual cursor may be a simple graphical element, such as an arrow, or a representation of a hand. It may also simply highlight or identify a UI element (without the explicit graphical representation of the cursor on the screen), such as by changing the color of the UI element, or projecting a glow behind it. The virtual cursor may also be used to select the screen as an object to be manipulated, as described below.

At stage 940, the sensed data is used by a gesture recognition component to detect gestures that may be performed by the subject. The gesture recognition component may include elements described in U.S. Pat. No. 7,970,176, entitled “Method and System for Gesture Classification”, and U.S. application Ser. No. 12/707,340, entitled “Method and System for Gesture Recognition”, which are fully incorporated herein by reference. In this context, gestures may be detected based on input from any of the perceptual sensing technologies. In particular, a gesture may be detected based on tracking of the hands and fingers, or tracking of the user's gaze, or based on the user's spoken words. There are two categories of gestures that trigger events: select gestures and manipulate gestures. Select gestures indicate that a specific UI element should be selected.

In some embodiments, a select gesture is a grabbing movement of the hand, where the fingers move towards the center of the palm, as if the subject is picking up a UI element. In some embodiments, a select gesture is performed by moving a finger or a hand in a circle, so that the virtual cursor encircles the UI element that the subject wants to select. In some embodiments, a select gesture is performed by speaking a word or phrase, such as “this” or “that”. In some embodiments, a select gesture is performed by touching a touch screen at a prescribed position. In some embodiments, a select gesture is performed by directing the gaze directly at a position on the screen for a prescribed amount of time. Of course, other gestures may be defined as a select gesture, whether their detection relies on depth cameras, RGB cameras, gaze detection technology, touch screens, speech recognition technology, or any other perceptual sensing technology.

At stage 960, the system evaluates whether a select gesture was detected at stage 940, and, if, indeed, a select gesture has been detected, at stage 980 the system determines whether a virtual cursor is currently mapped to one or more UI elements. The virtual cursor is mapped to a UI element when the virtual cursor is positioned over a UI element. In the case where a virtual cursor has been mapped to a UI element(s), the UI element(s) may be selected at stage 995. If a virtual cursor has not been mapped to a UI element(s), then no UI element(s) is selected even though a select gesture was detected at stage 960.

In addition to select gestures, another category of gestures, manipulate gestures, are defined. Manipulate gestures may be used to manipulate a UI element in some way.

In some embodiments, a manipulate gesture is performed by the user rotating his/her hand, which in turn, rotates the UI element that has been selected, so as to display additional information on the screen. For example, if the UI element is a directory of files, rotating the directory enables the subject to see all of the files contained in the directory. Additional examples of manipulate gestures may include turning the UI element upside down to empty its contents, for example, onto a virtual desktop; shaking the UI element to reorder its contents, or have some other effect; tipping the UI element so the subject can “look inside”; squeezing the UI element, which may have the effect, for example, of minimizing the UI element; or moving the UI element to another location. In some embodiments, a swipe gesture may move the selected UI element to the recycle bin. In some embodiments, the manipulate gesture is performed with the user's gaze, for example, for moving an icon around the screen. In some embodiments, instructions for a manipulate gesture are given based on speech. For example, the user may say “look inside” in order to tip the UI element and view the contents, or the user may say “minimize” to cause the UI element to be minimized.

At stage 950, the system evaluates whether a manipulate gesture has been detected. In the case that a manipulate gesture was detected, then at stage 970, the system checks whether there is a UI element that has previously been selected. If a UI element has been selected, it may then be manipulated at stage 990, according to the particular defined behavior of the performed gesture, and the context of the system. In some embodiments, one or more respective cursors identified with the respective fingertips may be managed to enable navigation, command entry or other manipulation of screen icons, objects or data, by one or more fingers. If a UI element has not been selected, then no UI element(s) is manipulated even though a manipulate gesture was detected at stage 950.

In some embodiments, a virtual cursor is controlled based on the direction of a user's gaze, and a perceptual sensing technology tracks the user's gaze direction. A virtual object is selected when the virtual cursor is mapped to the virtual object and the user performs a pinch gesture or when the user performs a grab gesture. Then the virtual object is moved by the user by gazing toward the direction in which the user wishes the virtual object to move.

In some embodiments, the virtual cursor is controlled based on the tracked direction of a user's gaze, and then an object is selected by the user through a pinch or grab gesture, as performed by the hand. Then the selected object is moved around the screen based on the movements of one or both of the user's hands.

In some embodiments, the virtual cursor is controlled based on the tracked positions of the user's hand and fingers, and certain keywords in the user's speech are used to select the objects. For example, the user can point to an object on the screen and say, “Put this over there”, and the object he is pointing to when he says the word “this” is moved to the position on the screen he is pointing to when he says the word “there”.

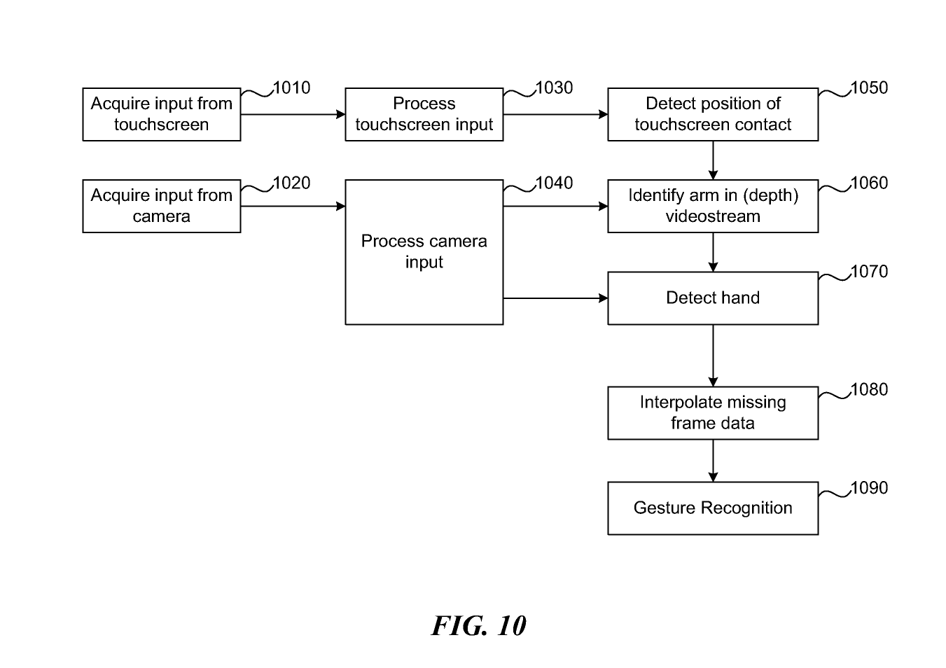

Refer to FIG. 10 which is a workflow diagram describing a user interaction based on multiple perceptual sensing technologies. In particular, the system includes a touch screen and a camera (either RGB or depth, or both). At stage 1010, input is acquired from the touch screen. Then the touch screen input is processed at stage 1030 by a touch screen tracking module that applies a touch screen processing algorithm to the touch screen input to compute the position on the screen touched by the user.

As an output of the touch screen processing algorithm, a touch may be detected at stage 1050, and the description of this touch—information describing the screen location, amount of pressure, etc.—as computed by the touch screen tracking module, is saved. In some embodiments, this touch description may be a single finger touching the screen. In some embodiments, this touch description may be two fingers touching the screen in close proximity to one another, forming a pinch gesture. In some embodiments, this touch description may be four or five of the fingers in close proximity to one another, touching the touch screen.

While touch screen input is acquired at stage 1010, at stage 1020, input is acquired from the camera(s). Then the camera videostream is processed at stage 1040 by a camera tracking module that applies a camera processing algorithm to the camera input to compute the configuration of the user's hand(s).

Subsequently, as an output of the camera processing algorithm, the position of the user's arm is computed at stage 1060 and also identifies which of the user's hands touched the screen. Then, the output of the camera processing algorithm is monitored to detect the hand that touched the screen, as it moves back away from the screen 1070. In some embodiments, the camera may be positioned such that it has a clear view of the touch screen, and in this case, the hand is visible even at the instant the touch screen is touched. In some embodiments, the camera is positioned either at the top or the bottom of the screen, and may not have a clear view of the user's hand when the hand is in close proximity to the screen. In this case, the hand may not be detected until the user begins moving it away from the touch screen, and the hand enters the camera's field-of-view. In both scenarios, once the hand is detected, at stage 1080, if there were missing frames between the time when the touch screen was touched, and the hand's finger(s) were detected, e.g., if the camera does not have a clear view of the touch screen, the locations of the finger(s) in the missing frames are computed by interpolating the 3D positions of the finger(s) between the known position of the touch screen position computed at stage 1050 and the known positions of the finger(s) computed at stage 1070. The interpolation may be linear, or may be based on splines, or on other accepted ways to interpolate data between frames.

The full set of 3D positions of the fingers may then be transferred to a gesture recognition module which determines at stage 1090 if a gesture was performed based on the 3D positions of the finger(s) over the set of frames.

In some embodiments, a gesture of the finger touching the touch screen and moving back away from the touch screen can be detected. In some embodiments, this gesture may depend on the velocity of the movements of the finger(s), where a fast movement of the finger(s) away from the screen activates one response from the system, while a slow movement of the finger(s) away from the screen activates a different response from the system. In some embodiments, the detected gesture may be a pinch at the screen, and then the fingers open while the hand moves away from the screen. In some embodiments, the detected gesture may be a grabbing motion where the fingers of the hand close toward the palm, with the fingers opening up away from the palm of the hand as the hand moves away from the touch screen.

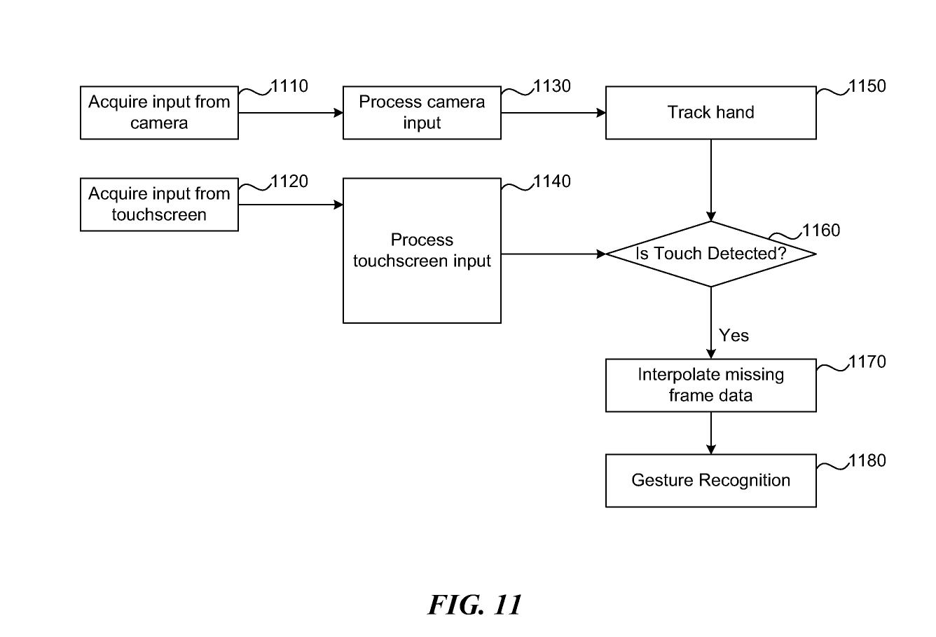

Refer to FIG. 11, which is a workflow diagram describing another user interaction based on multiple perceptual sensing technologies. In particular, the system includes a camera (either RGB or depth, or both) and a touch screen. At stage 1110, input is acquired from the camera(s). Then the camera input is processed at stage 1130 by a camera tracking module that receives the videostream from the camera and computes the configurations of the hands and fingers. A hand may be detected at stage 1150, and the 3D positions of the hand's joints are saved as long as they are tracked by the camera.

While camera input is acquired at stage 1110, at stage 1120, input is acquired from the touch screen. Then at stage 1140, the touch screen input is processed to compute the location on the screen that was touched. There may be a touch detected on the touch screen at stage 1160. When the touch is detected at stage 1170, any missing frames of data between the last known hand joint positions and the detected touch on the touch screen may be interpolated. This interpolation may be linear, or may be based on splines, or based on other accepted ways to interpolate data between frames. Subsequently, the entire set of frames data is used by the gesture recognition module to determine whether a gesture is detected at stage 1180.

In some embodiments, a gesture of the hand moving towards a region of the touch screen and touching the screen at that region may be detected. In some embodiments, this gesture may depend on the velocity of the hand as it approaches the touch screen. In some embodiments, a gesture may be performed to indicate a certain action, and then the action is applied to all icons which are subsequently touched. For example, a gesture may be performed to open a new folder, and all objects that are touched after the gesture is performed are moved into the opened folder. In some embodiments, additional information about the user's actions in touching the touch screen, as determined by a camera and camera tracking module, may be incorporated. For example, the angle of the user's finger as the screen is touched may be computed by the camera tracking module, and this data can be considered and utilized by the application. In another example, the camera tracking module can identify which finger of which hand is touching the screen, and incorporate this additional information into the application.

The present disclosure may also be used to limit the possibility of false positives in the interpretation of the user's intentions. In some embodiments, virtual objects are selected via a gesture identifiable by a camera, such as a pinch or grab gesture, but the object is selected only if the user's gaze is simultaneously detected as looking at the object to be selected. In some embodiments, an automobile may be equipped with speech recognition technology to interpret a user's verbal instructions, and a camera to detect the user's hand gestures. False positives of the user's speech may be limited by requiring the performance of a gesture to activate the system. For example, the user may be able to command the phone to call someone by using the “Call” voice command and then specifying a name in the phone directory. However, the phone will only initiate the call if the user performs a pre-defined gesture clarifying his intentions. In some embodiments, camera-based tracking may be used to identify which of multiple users is speaking, to improve the quality of the speech recognition processing, particularly in noisy environments.

U.S. patent application Ser. No. 13/310,510, entitled “System and Method for Automatically Defining and Creating a Gesture” discloses a method for creating gestures by recording subjects performing the gesture of interest and relying on machine learning algorithms to classify the gesture based on the subjects' actions in the training data. The application is hereby incorporated in its entirety. In the present disclosure, the user's actions as sensed by additional perceptual sensing technologies, such as touch screens, speech recognition, and gaze detection, may also be included in the creation of gestures. For example, the definition of a gesture(s) can include a specific number of and specific location of touches on the touch screen, certain phrases or sounds to be spoken, and certain gazes to be performed, in addition to hand, finger, and/or other body part movements. Additionally, test sequences and training sequences can be recorded for the user actions to be detected by the multiple perceptual sensing technologies.

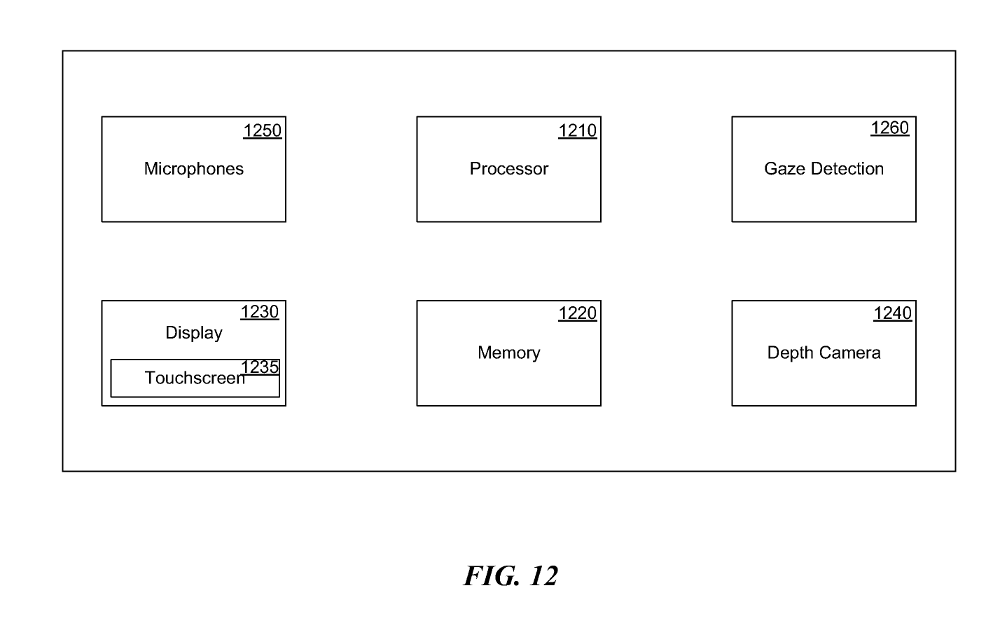

FIG. 12 shows a block diagram 1200 of a system used to acquire data about user actions using multiple perceptual sensing technologies and to interpret the data. The system may include one or more processors 1210, memory units 1220, display 1230, and sensing technologies that can include a touch screen 1235, a depth camera 1240, a microphone 1250, and/or gaze detection device 1260.

A processor 1210 may be used to run algorithms for processing the data acquired by the multiple sensing technologies. The processor 1210 can also provide feedback to the user, for example on the display 1230. Memory 1220 may include but is not limited to, RAM, ROM, and any combination of volatile and non-volatile memory.

The sensing technologies can include, but is not limited to, a touch screen 1235 that is part of the display 1230, a depth camera 1240 and/or a 2D camera, an acoustical sensing device such as a microphone 1250, and/or a gaze detection system 1260.

### Conclusion

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference in their entireties. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

1. A method comprising:
acquiring data about a user's actions using a plurality of perceptual sensing technologies;
analyzing the acquired data to identify a gesture from the user's actions, wherein the gesture is defined based upon information able to be detected by the plurality of perceptual sensing technologies.

2. The method of claim 1, wherein the gesture is performed by the user to interact with a user interface to control an electronic device.

3. The method of claim 2, wherein the plurality of perceptual sensing technologies includes a gaze detection system and a depth camera, wherein the user interface includes a cursor, and further wherein the gesture comprises gazing at the cursor on a screen and moving the user's gaze from the cursor to a virtual object on the screen to map the cursor to the virtual object, and performing a hand gesture to select the virtual object on the screen.

4. The method of claim 3, wherein the hand gesture is a pinch of two fingers.

5. The method of claim 3, wherein the hand gesture is a grabbing motion of a hand.

6. The method of claim 2, wherein the plurality of perceptual sensing technologies includes a depth camera and a microphone array, and wherein the user interface includes a cursor, and further wherein the gesture comprises a hand movement for controlling the cursor and spoken words for selecting or manipulating the cursor.

7. The method of claim 2, wherein the plurality of perceptual sensing technologies includes a gaze detection system and a microphone array, and wherein the user interface includes a cursor, and further wherein the gesture comprises gazing at the cursor and moving the user's gaze to control the cursor and spoken words for selecting or manipulating the cursor.

8. The method of claim 1, wherein the plurality of perceptual sensing technologies includes a depth camera and a gaze detection system, wherein the data acquired from the depth camera is a select gesture made by the user's hand for selecting a virtual object on a screen, and wherein the data acquired from the gaze detection system is a gaze at the selected virtual object, wherein the gaze detection reduces a false positive in identifying the virtual object selected by the user.

9. The method of claim 1, wherein the plurality of perceptual sensing technologies includes a touch screen and a depth camera.

10. The method of claim 9, wherein the data acquired from the touch screen is a location of a touch on the touch screen, and further wherein the data acquired from the depth camera identifies which one of a user's fingers touched the touch screen.

11. The method of claim 9, wherein the data acquired from the touch screen is multiple locations of multiple touches on the touch screen, and further wherein the data acquired from the depth camera identifies whether the multiple touches are from only the user or from the user and one or more other users.

12. The method of claim 9, wherein the data acquired from the touch screen is a location of a touch on the touch screen, and further wherein the data acquired from the depth camera is an angle with which the user's finger touched the touch screen.

13. The method of claim 9, wherein the data acquired from the touch screen is a location of a touch on the touch screen, and further wherein the data acquired from the depth camera identifies which one of the user's hands touched the touch screen.

14. The method of claim 1, wherein the plurality of perceptual sensing technologies includes a touch screen and a depth camera, and further wherein the gesture comprises a touch on the touch screen and subsequent movement away from the touch screen.

15. The method of claim 1, wherein the plurality of perceptual sensing technologies includes a depth camera and a touch screen, and further wherein the gesture comprises a hand and finger movement a distance from the touch screen and a subsequent touch on the touch screen.

16. A system comprising:
a plurality of perceptual sensors configured to acquire data about a user's actions;
a processing module configured to analyze the acquired data to identify a gesture from the user's actions,
wherein the gesture is defined based upon data able to be detected by the plurality of perceptual sensors.

17. The system of claim 16, further comprising a user interface application module configured to allow the user to control an electronic device based on the identified gesture.

18. The system of claim 16, wherein the plurality of perceptual sensors includes a touch screen and a depth camera, and further wherein the data acquired by the depth camera augments the data acquired by the touch screen.

19. The system of claim 16, wherein the plurality of perceptual sensing technologies includes a gaze detection system and a depth camera, wherein the user interface includes a cursor, and further wherein the gesture comprises gazing at the cursor on a screen and moving the user's gaze from the cursor to a virtual object on the screen to map the cursor to the virtual object, and performing a hand gesture to select the virtual object on the screen.

20. The system of claim 16, wherein the plurality of perceptual sensing technologies includes a depth camera and a gaze detection system, wherein the data acquired from the depth camera is a select gesture made by the user's hand for selecting a virtual object on a screen, and wherein the data acquired from the gaze detection system is a gaze at the selected virtual object, wherein the gaze detection reduces a false positive in identifying the virtual object selected by the user.

21. A system comprising:
a first means for acquiring data about a user's action;
a second means for acquiring data about the user's action;
one or more processing modules configured to analyze the acquired data to identify a gesture from the user's actions,
wherein the gesture is defined based upon data able to be detected by the first means for acquiring data and the second means for acquiring data.

22. The system of claim 21, further comprising a user interface application module configured to allow the user to control an electronic device based on the identified gesture.
